(19) United States
(12) Patent Application Publication
(10) Pub. No.: US 2014/0201226 A1
(43) Pub. Date: Jul. 17, 2014

(54) IMAGE DISPLAY METHOD AND ELECTRONIC DEVICE USING THE SEME

(71) Applicants: Kuo-Chung Chiu, Taipei City (TW); Wen-Chieh Tseng, Taipei City (TW); Ping-Cheng Hsieh, Taipei City (TW)

(72) Inventors: Kuo-Chung Chiu, Taipei City (TW); Wen-Chieh Tseng, Taipei City (TW); Ping-Cheng Hsieh, Taipei City (TW)

(73) Assignee: ASUSTEK COMPUTER INC., Taipei City (TW)

(21) Appl. No.: 14/149,827

(22) Filed: Jan. 8, 2014

Related U.S. Application Data
(60) Provisional application No. 61/751,948, filed on Jan. 14, 2013.

(30) Foreign Application Priority Data
Nov. 15, 2013 (TW) 102141665

(51) Int. Cl. G06F 17/30

(52) U.S. Cl. CPC G06F 17/30247
USPC 707/758

(57) ABSTRACT

A display method and an electronic device using the same are provided. The electronic device includes a screen. The display method comprises the follow steps: detecting a display specification of the electronic device; determining whether a first database includes a candidate image which is appropriate to the display specification; if the first database does not include the candidate image which is appropriate to the display specification, getting an original image from a second database and adjusting the original image into a display image which is appropriate to the display specification, and displaying the display image on the screen.

### CROSS-REFERENCE TO RELATED APPLICATION

This application claims the priority benefit of U.S. provisional application Ser. No. 61/751,948, filed on Jan. 14, 2013 and Taiwan application serial no. 102141665, filed on Nov. 15, 2013. The entirety of each of the above-mentioned patent applications is hereby incorporated by reference herein and made a part of specification.

### BACKGROUND OF THE INVENTION

1. Field of the Invention

The invention relates to a man-machine interface display technology and, more particularly to an image display method and an electronic device using the same.

2. Description of the Related Art

As technology develops, electronic devices, such as cell phones, smart phones, personal digital assistant (PDA) phones, tablet computers and notebook computers, are widely used in daily life. Conventionally, operating systems of the electronic devices, such as iOS of Apple and Android of Google, allow users to install third-party applications, and thus the user can directly download the third-party applications from the internet to the electronic devices.

However, a graphical user interface (GUI) generated by the operating system of the electronic device may be not appropriate to a display specification of the electronic device. For example, when the third-party application is downloaded to the electronic device, the maximum resolution of images for the application is 96×96 px. Therefore, if the application is displayed in a higher resolution (such as 144×144 px), the image should be stretched in a conventional way. Since the maximum resolution of image (96×96 px) is smaller than the higher resolution (144×144 px), the image may be unclear and uncoordinated when it is displayed in the display specification of the electronic device with the higher resolution.

### BRIEF SUMMARY OF THE INVENTION

A display method applied to an electronic device is provided. The electronic device includes a screen. The display method includes the following steps: detecting a current display specification of the electronic device; determining whether a first database includes a candidate image which is appropriate to the display specification, and the first database is in the electronic device; if the first database does not include the candidate image which is appropriate to the display specification, getting an original image from a second database and adjusting the original image into a display image which is appropriate to the display specification, and displaying the display image on the screen.

An electronic device including a screen, a storage unit and a processing unit is provided. The storage unit is used for storing a first database, and the first database includes a plurality of candidate images. The processing unit is coupled to the screen and the storage unit, and the processing unit detects a current display specification of the electronic device and determines whether the first database includes the candidate image which is appropriate to the display specification. If the first database does not include the candidate image which is appropriate to the display specification, the processing unit gets an original image from a second database and adjusts the original image into a display image which is appropriate to the display specification, and then the display image is displayed on the screen.

In conclusion, the electronic device gets the image with the appropriate resolution according to the display specification and displays according to the image. As a result, the electronic device provides a clear and coordinated image.

### BRIEF DESCRIPTION OF THE DRAWINGS

FIG. 1 is a block diagram showing an image display system in a first embodiment;

FIG. 2 is a flowchart showing a display method in an embodiment;

FIG. 3 is a diagram showing that an electronic device gets an image which is appropriate to a display specification of the electronic device from a first database or a second database in an embodiment; and

FIGS. 4A and 4B are diagrams showing a hybrid mobile device before and after assembly in an embodiment.

### DETAILED DESCRIPTION OF THE EMBODIMENTS

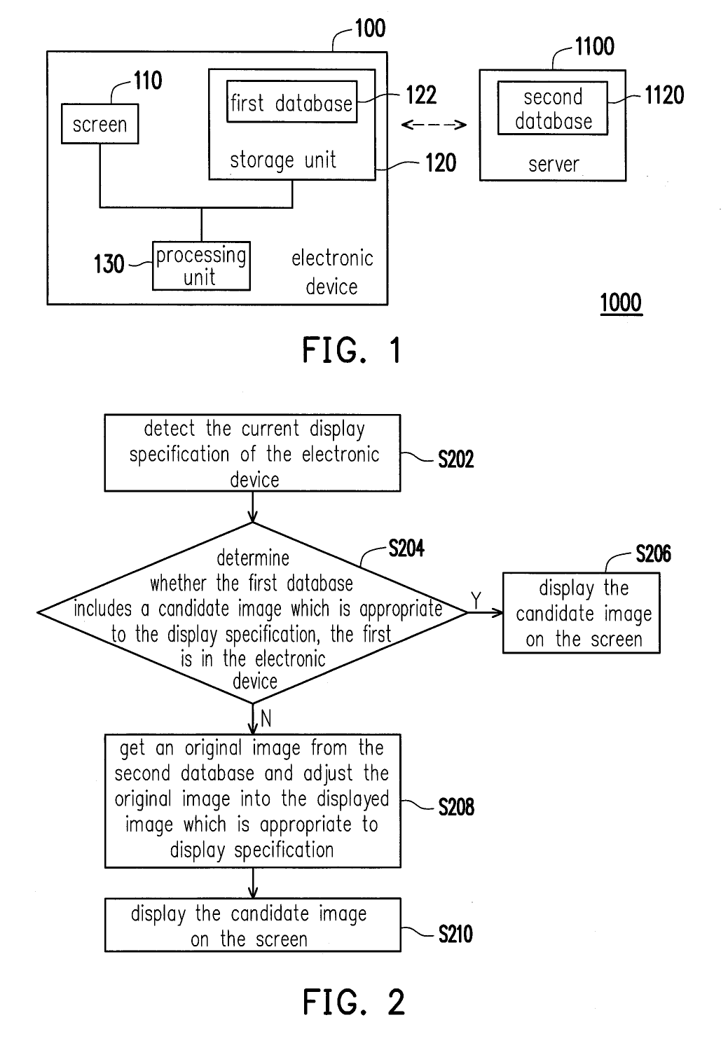

FIG. 1 is a block diagram showing an image display system in a first embodiment. Please refer to FIG. 1, an image display system 1000 includes an electronic device 100 and a server 1100, the electronic device 100 is connected to the server 1100 through the internet, which is not limited herein.

The electronic device 100 may be a cell phone, a smart phone, a personal digital assistant (PDA) phone, a tablet computer or a notebook computer, which is not limited herein. The electronic device 100 includes a screen 110, a storage unit 120 and a processing unit 130, and the processing unit 130 is coupled to the screen 110 and the storage unit 120.

The screen 110 is used for displaying information of the electronic device 100, such as graphical user interfaces (GUIs), applications, widgets and other interfaces, which is not limited herein. The screen 110 can be all types of touch screens, such as resistive, capacitive or optical touch screens, which is not limited herein. In an embodiment, the screen 110 may be a liquid crystal display (LCD) screen which is only equipped with a display function.

The storage unit 120 is used for storing a first database 122, and the first database 122 includes a plurality of candidate images. Images of the graphical user interfaces (GUIs), applications, widgets and other interfaces displayed on the screen 110 can be stored in the first database 122 of the storage unit 120. In order to optimize the graphical user interfaces (GUIs), applications, widgets and other interfaces to fit sizes or densities of different screens 110, the first database 122 can store a plurality of candidate images in the same style but with different resolutions. Consequently, when the electronic device 100 has the screens 110 of different sizes or densities, it can select a suitable candidate image to achieve the optimized effect. Consequently, the electronic device 100 can select an appropriate candidate image from the candidate images to display in different operating environments to fit to the current display specification of the electronic device 100. In the embodiment, the storage unit 120 may be an embedded internal storage unit or an external storage unit. The internal storage unit may be a random access memory (RAM), a read-only memory (ROM), a flash memory, or a magnetic disk storage device, which is not limited herein. The external storage unit may be a compact flash (CF), a secure digital memory card (SDMC), a micro SDMC, or a memory stick (MS), which is not limited herein.

The processing unit 130 may be one or combination of hardware (such as chipsets and processors), software (such as operating systems and applications), with computing capabilities, so as to control the general operations of the electronic device 100. In detail, the processing unit 130 gets the display specification of the electronic device 100 in the current operating environment and selects an candidate image which is appropriate to the display specification from the first database 122 of the storage unit 120, or the processing unit 130 gets an original image corresponding to the current operating environment from the server 1100 through the internet and adjusts the original image to generate a display image which is appropriate to the current display specification, as a result, the candidate image or the display image is displayed on the screen 110. In the embodiment, the processing unit 130 may be a central processing unit (CPU), a programmable microprocessor, a digital signal processor (DSP), a programmable controller, an application specific integrated circuits (ASIC), a programmable logic device (PLD), which is not limited herein.

In addition, the server 1100 may be a web server or a cloud server, and it includes a second database 1120. The second database 1120 includes a plurality of original images. The original images corresponding to the images with higher resolutions which are downloaded on the electronic device 100, and the resolution may be 512×512 px, which is not limited herein. In detail, the second database 1120 stores the images in the same style but with higher resolutions for the images of the graphical user interfaces, applications, widgets and other interfaces of the electronic device 100, Thus, the electronic device 100 can get the original image from the second database 1120 and adjusts the resolution of the original image to fit the display specification of the electronic device 100 in the current operating environment.

The steps of a display method cooperated with the electronic device 100 are described hereafter. FIG. 2 is a flowchart showing a display method in an embodiment. Please refer to the FIG. 2. In step S202, the processing unit 130 detects the current display specification of the electronic device 100. In detail, the electronic device 100 may have a plurality of display specifications, such as the display specification of the electronic device 100 in a portrait displaying mode or in a landscape displaying mode, or the display specification of the electronic device 100 which is coupled to another electronic device. The display specifications may be the appropriate resolution of the image displayed on the screen 10, such as 36×36 px, 48×48 px, 72×72 px, 96×96 px, or 144×144 px, which is not limited herein. In addition, the image may be an image or an icon of a graphical user interface, an application, a widget, or a wall paper, a photo and a region of interesting in other interfaces, which is not limited herein. In the embodiment, once the electronic device 100 adds an application or a widget (which is not limited herein), the processing unit 130 detects the current display specification of the electronic device 100 to get an appropriate resolution for the image corresponding to the application and the widget.

In step S204, the processing unit 130 determines whether the first database 122 of the storage unit 120 includes the candidate image which is appropriate to the current display specification of the electronic device 100. In detail, the processing unit 130 calculates the resolution of the image which is appropriate to the current display specification, and determines whether the first database 122 includes the candidate image which is appropriate to the resolution. That means, the processing unit 130 searches the candidate image according to the image of the graphical user interfaces, applications, widgets and other interfaces displayed on the screen 110, and the candidate image is appropriate to the current resolution of the electronic device 100 in the first database 122.

If the first database 122 includes the candidate image which is appropriate to the current display specification of the electronic device 100, in step S206, the processing unit 130 displays the candidate image on the screen 110. However, if the first database 122 does not include the candidate image which is appropriate to the current display specification of the electronic device 100, in step S208, the processing unit 130 gets the original image from the second database 1120 of the server 1100 via the internet and adjusts the resolution of the original image to fit the current display specification of the electronic device 100. The way of adjusting the resolution may be zooming in or zooming out the original image according to a preset ratio, or cutting the original image into a plurality of equal macro blocks and zooming in or zooming out the macro blocks according to the preset ratio, which is not limited herein. In step S210, the processing unit 130 displays the display image on the screen 110. Moreover, the processing unit 130 further stores the display image in the first database 122, which helps the processing unit 130 to get the display image whose resolution is appropriate to current display specification of the electronic device 100 from the first database 122.

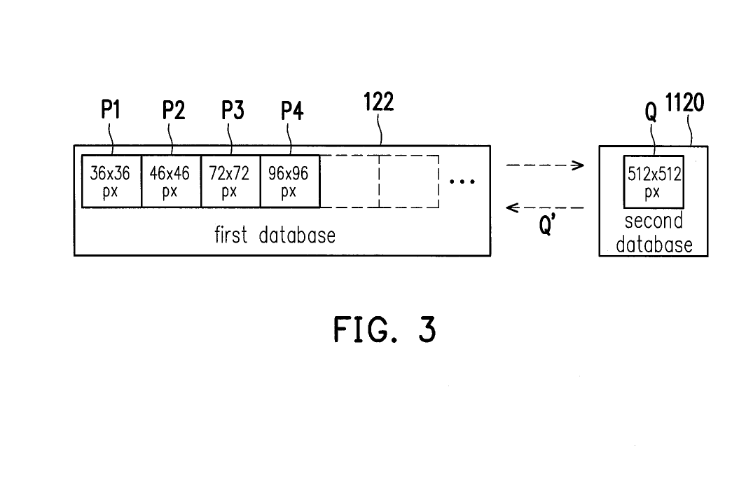

In an embodiment, FIG. 3 is a diagram showing the electronic device 100 getting an image which is appropriate to the display specification of the electronic device 100 from the first database 122 or the second database 1120. Please refer to FIG. 3, if the processing unit 130 loads a graphical user interface with an image (the image P0), and the first database 122 stores candidate images P1 to P4, and resolutions of the images P1 to P4 are different from the resolution of the image P0, but their style are the same. The resolutions of the candidate images P1 to P4 may be 36×36 px, 48×48 px, 72×72 px and 96×96 px, and the number of the images and the resolutions are not limited herein. If the resolution appropriate to the display specification of the electronic device 100 is 72×72 px, when the processing unit 130 loads the graphical user interface with the image P0, the processing unit 130 selects the candidate image P3 with the resolution of 72×72 px in the first database 122, and the graphical user interface is loaded via the candidate image P3 instead of the image P0.

However, if the resolution that is appropriate to the current display specification of the electronic device 100 is 144×144 px, the first database 122 does not include the candidate image with the resolution of 144×144 px, therefore, the processing unit 130 is connected to the second the database 1120 of the server 1100 to get an original image Q corresponding to image P0, and the resolution of the original image Q is 512×512 px, which is not limited herein. Then, the processing unit 130 adjusts the original image to convert the original image Q with the resolution of 512×512 px into a display image Q′ with the resolution of 144×144 px. Thus, the processing unit 130 displays the display image Q′ with the resolution of 144×144 px to provide a clear image. In addition, the processing unit 130 stores the display image Q′ with the resolution of 144×144 px in the first database 122, which helps the processing unit 130 to directly get the display image Q′ with the resolution of 144×144 px from the first database 122.

When an operation event is generated, the processing unit 130 executes the steps S202 to S210 to adjust the image displayed on the screen 110, so as to make the resolution of the image fit the current display specification of the electronic device 100. The operation event may be enabling the electronic device 100, rotating the electronic device 100, or coupling the electronic device 100 to another electronic device, which is not limited herein. Thus, the electronic device 100 can provide a clear visual image in different operating environments.

In detail, the electronic device 100 is selectively equipped with a sensor unit (not shown), and the sensor unit is coupled to the processing unit 130. The sensor unit may be a touch sensor, a gravity sensor, a gyro sensor or a compass sensor, which is used for sensing the current displaying mode of the electronic device 100, such as a portrait displaying mode or a landscape displaying mode. For example, when the electronic device 100 is enabled or rotated, the processing unit 130 determines whether the current displaying mode of the electronic device 100 is the portrait displaying mode or the landscape displaying mode according to the gravity direction detected by the sensor unit.

For example, if the processing unit 130 detects the display specification in the portrait displaying mode when the electronic device 100 is enabled, the appropriate resolution of the image displayed on the screen 110 is 144×144 px. If the first database 122 includes the candidate image with the resolution of 144×144 px, the processing unit 130 displays the candidate image directly on the screen 110. However, if the first database 122 does not include the candidate image with the resolution of 144×144 px, the processing unit 130 gets an original image from the second the database 1120 of the server 1100 (such as the original image with resolution of 512×512 px) and adjusts the original image into the display image with resolution of 144×144 px, and displays the display image on the screen 110. Similarly, if the processing unit 130 detects the display specification in the landscape displaying mode when the electronic device 100 is enabled, the appropriate resolution of the image displayed on the screen 110 is 96×96 px. The processing unit 130 also can display the image according to the steps S202 to S210, which is omitted herein for a concise purpose.

On the other hand, when the electronic device 100 is rotated, the processing unit 130 can detect the current display specification of the electronic device 100, the sensor unit can sense whether it is from the portrait displaying mode to the landscape displaying mode (or vice versa). Consequently, the processing unit 130 executes the steps S204 to S210 to change the image originally displayed on the electronic device 100 according to the current display specification of the electronic device 100, and displays the image which is appropriate to the current display specification of the electronic device 100 on the screen 110.

In an embodiment, when the electronic device 100 is coupled to a second electronic device, the processing unit 130 can also detect the display specification of the second electronic device, and displays an image on the screen of the second electronic device, and the image is appropriate to the display specification of the second electronic device.

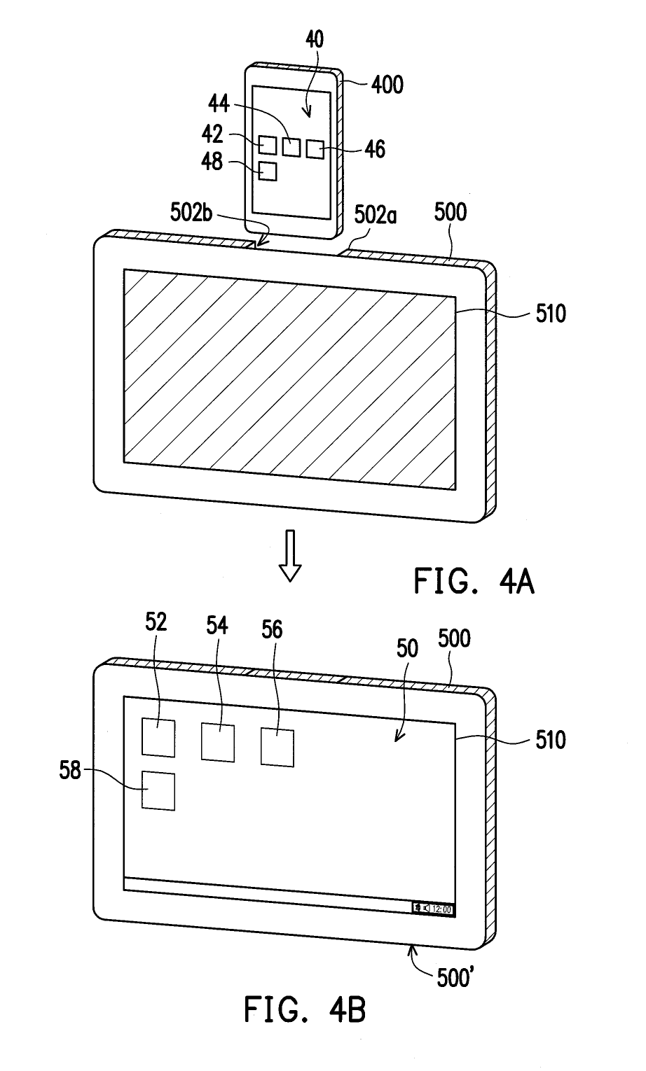

FIGS. 4A and 4B are diagrams showing a hybrid mobile device before and after assembly in an embodiment, and the function of an electronic device 400 is same or similar to the electronic device 100. Please refer to FIG. 4A, in the embodiment, the electronic device 400 is coupled to a second electronic device 500 via a port (not shown) of the electronic device 400. The second electronic device 500 is equipped with a screen 510 and receives a control signal to display an image after the second electronic device 500 is coupled to the electronic device 400. For example, the images 42 to 48 of a graphical user interface 40 of the electronic device 400 are mapped on a graphical user interface 50 (that is, the images 42 to 48 correspond to the images 52 to 58). In detail, the second electronic device 500 includes a slot (not shown) and a runner 502b on the reverse side 502a opposite to the side of the screen 510. Therefore, the electronic device 400 is coupled to the second electronic device 500 when it is inserted into the slot along the runner 502b via the port, then, the electronic device 400 and the second electronic device 500 form a hybrid mobile device 500′ (shown as FIG. 4B).

In the embodiment, the display specification of the screen 410 of the electronic device 400 and that of the screen 510 of the second electronic device 500 are different. For example, the resolution of the screen 410 of the electronic device 400 is 480×320 px, and the resolution of the screen 510 of the second electronic device 500 is 1024×768 px. In the embodiment, the electronic device 400 is a mobile phone, and the second electronic device 500 is a tablet computer, which is not limited herein.

In the embodiment, when the electronic device 400 is coupled to the second electronic device 500 to form the hybrid mobile device 500′, a processing unit of the electronic device 400 detects the display specification of the second electronic device 500. If the processing unit of the electronic device 400 detects that the display specification of the second electronic device 500 is 144×144 px, when the electronic device 400 displays the images 52 to 58 corresponding to the images 42 to 48 on the screen 510, the processing unit of the electronic device 400 determines whether the first database 122 includes the candidate image with the resolution of 144×144 px corresponding to the images 42 to 48. If yes, the electronic device 400 displays the candidate image on the screen 510 accordingly. If not, the electronic device 400 is connected to a server to get the original image corresponding to the images 42 to 48 in the second database, and adjusts the original image into the display image whose resolution is appropriate to the display specification of the second electronic device 500 and displays the display image (the adjusted original image) on the screen 510. As a result, when the electronic device 400 is coupled to the second electronic device 500 and displays the image via the screen 510, the image of the screen 510 has better visual coordination.

In conclusion, if the first database of the electronic device includes the candidate image which is appropriate to the current display specification of the electronic device, the electronic device displays the image according to the candidate image. If not, the electronic device gets the original image from the server to adjust the original image into the display image which is appropriate to the current display specification, and displays the image according to the display image. Thus, the electronic device displays the image with appropriate resolution according to the current display specification. As a result, the electronic device provides the clear and coordinated image.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A display method, applied to an electronic device, wherein the electronic device includes a screen, the method comprising following steps:
detecting a current display specification of the electronic device;
determining whether a first database includes a candidate image which is appropriate to the display specification, wherein the first database is in the electronic device;
if the first database does not include the candidate image which is appropriate to the display specification, getting an original image from a second database and adjusting the original image to be appropriate to the display specification; and
displaying the display image on the screen.

2. The display method according to claim 1, wherein the step of determining whether the first database includes the candidate image which is appropriate to the display specification comprising:
calculating a resolution which is appropriate to the display specification; and
determining whether the first database includes the candidate image which is appropriate to the resolution.

3. The display method according to claim 1, further comprising:
displaying the candidate image on the screen if the first database includes the candidate image which is appropriate to the display specification.

4. The display method according to claim 1, further comprising:
when an operation event is generated, executing the step of detecting the display specification of the electronic device, wherein the operation event includes adding at least one application on the electronic device, enabling the electronic device, rotating the electronic device, coupling the electronic device to a second electronic device.

5. The display method according to claim 1, further comprising:
storing the display image in the first database.

6. An electronic device, comprising:
a screen;
a storage unit, used for storing a first database, wherein the first database includes a plurality of candidate images; and
a processing unit, coupled to the screen and the storage unit, wherein the processing unit detects a current display specification of the electronic device;
wherein the processing unit determines whether the first database includes the candidate image which is appropriate to the display specification, if the first database does not include the candidate image which is appropriate to the display specification, the processing unit gets an original image from a second database, adjusts the original image to a display image which is appropriate to the display specification and displays the display image on the screen.

7. The electronic device according to claim 6, wherein the processing unit calculates a resolution which is appropriate to the display specification, and determines whether the first database includes the candidate image which is appropriate to the display specification.

8. The electronic device according to claim 6, wherein if the first database includes the candidate image which is appropriate to the display specification, the processing unit displays the candidate image on the screen.

9. The electronic device according to claim 6, wherein when an operation event is generated, the processing unit executing the step of detecting the current display specification of the electronic device, and the operation event includes adding at least one application on the electronic device, enabling the electronic device, rotating the electronic device, coupling the electronic device to a second electronic device.

10. The electronic device according to claim 6, wherein the processing unit stores the display image in the first database.
